(19) United States
(12) Patent Application Publication
(10) Pub. No.: US 2004/0233244 A1
(43) Pub. Date: Nov. 25, 2004

(54) Printhead collision detection

(76) Inventors: Steven B. Elgee, Portland, OR (US); Geoff Wolton, Battleground, WA (US)

Correspondence Address: HEWLETT-PACKARD COMPANY, Intellectual Property Administration, P.O. Box 272400, Fort Collins, CO, 80527-2400, US

(21) Appl. No.: 10/442,517

(22) Filed: May 21, 2003

(51) Int. Cl. B41J 29/393; B41J 29/38

(52) U.S. Cl. 347/19; 347/8; 347/16; 400/55

(57) ABSTRACT

Systems, methods, and devices are provided for printhead collision detection. One embodiment includes a printing device having a printhead, a media conveyance mechanism operable to move print media to the printhead, and a detection mechanism operable to detect potential collisions between the print media and the printhead

### INTRODUCTION

Printing devices, such as inkjet, laser printers, and the like, operate according to control signals, commands, and/or computer readable instruction sets to effectuate the transfer of ink or other imaging material onto print media. Print media comes in many forms and can include draft paper, photo paper, cardstock, letterhead, envelopes, business cards, and transparencies, among others. In an inkjet printer, one or more controllers, such as microprocessors, regulate the movement of a carriage, holding one or more inkjet pens or printheads, across a print media. The controllers further regulate the timing and firing of the ink on to the print media.

In an inkjet printer, ink is projected onto the print media through one or more inkjet pens or printheads, each inkjet pen or printhead containing one or more nozzles. In a thermal inkjet printer, each printhead nozzle has an aperture and a firing resistor which heats a small quantity of ink held within the nozzle. A pulse of electrical energy is applied to the firing resistor, causing the ink within the nozzle to rapidly heat. The heat creates a vapor bubble which forms and expands within the ink. The expansion of the vapor bubble causes a droplet of ink to eject or jet through the aperture and onto the print media. One or more printhead nozzles are typically mounted in a movable carriage, and the movable carriage is moved across the print media. The print media is typically moved using a system of roller devices which move the print media across a platen and under the one or more printhead nozzles. As the needs of industry increase, so does the demand for faster print processes and thus more rapid print media delivery.

In some printers, e.g. large business class laser printers, the print media is held against the surface of a rotating printer drum. In these printers, the entire sheet of media is typically held against the surface of the rotating printer drum by using a vacuum. The printer drum is usually adapted with multiple apertures on the surface of the printer drum. A partial vacuum is created inside the printer drum, with the pressure differential causing the print media to adhere to the surface of the printer drum. In other printers adherence of the print media to the printer drum can be accomplished by the use of electrostatic force, adhesives, or by utilizing one or more clips, clamps, pins, among others. These drum-type printers generally have the advantage of providing faster print media delivery than is available with typical existing roller and platen printers.

The quality of the resulting printed image from inkjet printers depends on the trajectory of the ejected ink droplet. The quality of the printed image also depends on the distance between the printhead nozzle aperture and the print media. If the nozzle aperture is located too far from the print media, the ejected ink droplets can deviate from the intended trajectory, causing poor print resolution. Therefore, it is advantageous to position the printhead nozzles as close as possible to the surface of the print media. However, in doing so, problems can arise such as collisions between the printhead nozzles and the print media.

Printhead nozzles used in inkjet printing are typically a part of a complex integrated circuit. If print media is not positioned correctly during printing, the print media can become jammed or lodged between the printheads and the roller and platen delivery mechanism, possibly damaging the delicate printhead nozzles. Improper alignment of the media upon the rollers and platen wrinkles or folds in the media, and absorption of moisture into the media can cause media jams. Locating the printheads close to the print media increases the likelihood that the print media will damage the printhead nozzles. This potential for nozzle damage is more severe with drum-type printing than with roller and platen-type printing, due to the greater force exerted by the momentum of the rotating drum.

### BRIEF DESCRIPTION OF THE DRAWINGS

FIG. 1 illustrates a system with which embodiments can be implemented.

FIG. 2A illustrates a printing device with which embodiments can be implemented.

FIG. 2B illustrates a perspective view for a printer media conveyance mechanism embodiment.

FIG. 2C illustrates an embodiment of electronic components associated with a printer.

FIG. 3A illustrates a side view of an embodiment for a printhead protection device.

FIG. 3B illustrates portions of an embodiment for a media detection device.

FIG. 3C illustrates portions of another embodiment for a media detection device.

FIG. 4A illustrates a side view of another embodiment for a printhead protection detection device.

FIG. 4B illustrates a side view of another embodiment for a printhead protection device.

### DETAILED DESCRIPTION

The present invention provides techniques for printhead to print media collision detection. The present invention includes various embodiments that can be utilized to take remedial actions, such as halting movement of a printer drum, moving a printhead away from the printer drum, or redirecting printer media away from the printhead, to help prevent misaligned print media from striking and damaging the printhead.

Some printer designs propose using a drum-type conveyance mechanism with inkjet printheads. Drum-type conveyance has not been heavily employed with inkjet printing mechanisms since potentially significant printhead damage could arise from the greater force exerted by the momentum of the rotating drum. Drum-type conveyance is more frequently used with laser type printers where the issue of printhead proximity to the print media does not exist. Embodiments of the invention can serve to detect and, in some instances, take remedial action to avoid collisions between inkjet printheads and print media when conveyed with the added momentum of a rotating drum. As one of ordinary skill in the art will appreciate upon reading this disclosure, the application of the present invention is not limited to printers utilizing drum-type conveyance. There can be other types of print media conveyance that give rise to the risk of damage to printhead components. The present invention anticipates other types of print media conveyance that can involve relatively large amounts of inertia that present risk of damage to printheads. The present invention provides collision detection for such types of conveyance.

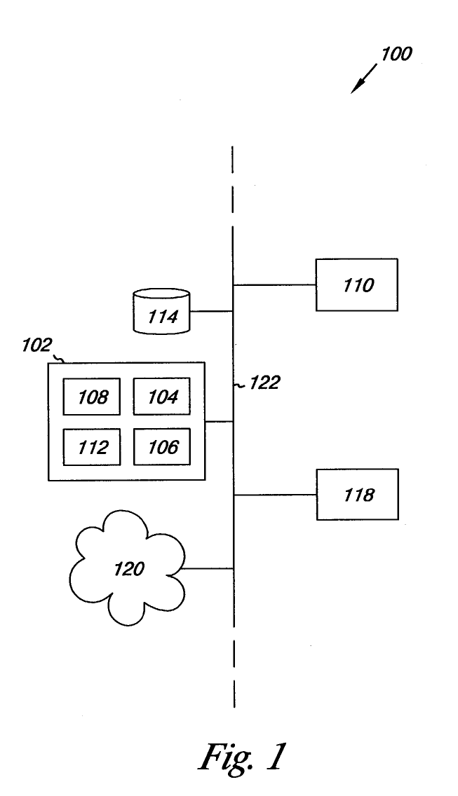

FIG. 1 illustrates a system environment 100 according to various embodiments of the present invention. As shown in FIG. 1, the system includes a printing device 102 and a scanning device (defined in the embodiment shown as a peripheral device 118). With regard to the various embodiments of the invention that can be utilized with a system such as the system 100 shown in FIG. 1, the printing device 102 is operable to print onto print media. In various embodiments of the invention, the scanning device peripheral 118 is operable to receive scan data.

The system 100 is operable to receive scan data and interpret the data by positioning the image in an associated image position. The system 100 can include software and/or application modules thereon for receiving and interpreting data in order to achieve the positioning and/or formatting functions. As one of ordinary skill in the art will appreciate, the software and/or application modules can be located on any device that is directly or indirectly connected to the printing device 102 and the scanning device peripheral 118 within the system 100.

In various embodiments, including the embodiment shown in FIG. 1, the printing device 102 can include one or more processors 104 and one or more memory devices 106. The one or more processors 104 are operable on implementing the method embodiments described in the claims. In the various embodiments, the one or more memory devices 106 include memory devices 106 on which data, including computer readable instructions, and other information of the like can reside.

In the embodiment shown in FIG. 1, the printing device 102 can include a printing device driver 108 and a print engine 112. In various embodiments of FIG. 1, additional printing device drivers can be located off the printing device, for example, on the remote device 110. Such printing device drivers can be an alternative to the printing device driver 108 located on the printing device 102 or provided in addition to the printing device driver 108. As one of ordinary skill in the art will understand, a printing device driver 108 is operable to create a computer readable instruction set for a print job utilized for rendering an image by the print engine 112. Printing device driver 108 includes any printing device driver suitable for carrying out various aspects of the present invention. That is, the printing device driver can take data from one or more software applications and transform the data into a print job.

As shown in the embodiment of FIG. 1, printing device 102 can be networked to one or more remote devices 110 over a number of data links, shown as 122. As one of ordinary skill in the art will appreciate upon reading this disclosure, the number of data links 122 can include one or more physical and one or more wireless connections, and any combination thereof, as part of a network. That is, the printing device 102 and the one or more remote devices 110 can be directly connected and can be connected as part of a wider network having a plurality of data links 122.

In various embodiments, a remote device 110 can include a device having a display such as a desktop computer, laptop computer, a workstation, hand held device, or other device as the same will be known and understood by one of ordinary skill in the art. The remote device 110 can also include one or more processors and/or application modules suitable for running software and can include one or more memory devices thereon.

As shown in the embodiment of FIG. 1, a system 100 can include one or more networked storage devices 114, e.g. remote storage database and the like, networked to the system. Likewise, the system 100 can include one or more peripheral devices 118, and one or more Internet connections 120, distributed within the network.

As one of ordinary skill in the art will appreciate upon reading this disclosure, the network described herein can include any number of network types including, but not limited to a Local Area Network (LAN), a Wide Area Network (WAN), Personal Area Network (PAN), and the like. And, as stated above, data links 122 within such networks can include any combination of direct or indirect wired and/or wireless connections, including but not limited to electrical, optical, and RF connections.

As one of ordinary skill in the art will appreciate upon reading this disclosure, memory, such as memory 106 and memory 114, can be distributed anywhere throughout a networked system. Memory, as the same is used herein, can include any suitable memory for implementing the various embodiments of the invention. Thus, memory and memory devices include fixed memory, such as a hard drive, a memory chip on a printed circuit board, a portable memory, such as a memory card, memory stick, flash card and the like. One of ordinary skill in the art will appreciate the manner in which software, e.g. computer readable instructions, can be stored on such memory medium. Other memory mediums include CDs, DVDs, and floppy disks. The invention, however, is not limited to any particular type of memory medium. And, the invention is not limited to where within a device or networked system a set of computer instructions reside for use in implementing the various embodiments of invention.

As stated above, the system embodiment 100 of FIG. 1 includes one or more peripheral devices 118. Peripheral devices can include any number of peripheral devices in addition to those already mentioned herein. Examples of peripheral devices include, but are not limited to, scanning devices, faxing devices, copying devices, modem devices, and the like. In the embodiment of FIG. 1, peripheral device 118 includes a scanning device.

The printing device 102 and the one or more peripheral devices, such as scanning device 118, can be individual devices. However, as one of ordinary skill in the art will appreciate upon reading this disclosure, the printing device 102 and the one or more peripheral devices, such as scanning device 118, can be combined into a multi-function device. For example, Hewlett Packard produces several devices that provide printing, copying, and scanning. Additionally, some of these multi-function devices also include faxing capabilities. These types of devices are generally referred to as PCS (Printing/Copying/Scanning) devices or as All-in-One (AiO) devices.

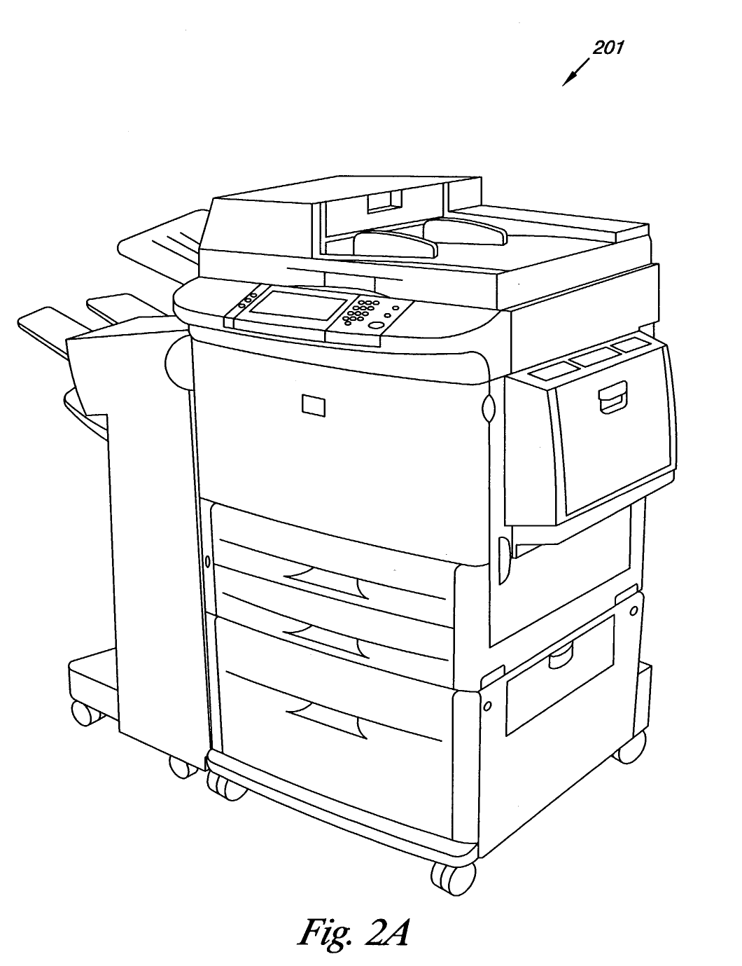

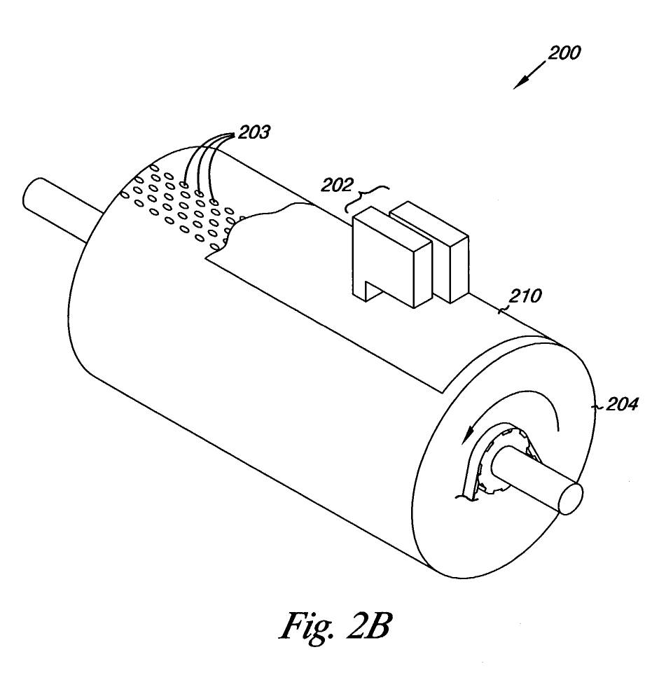

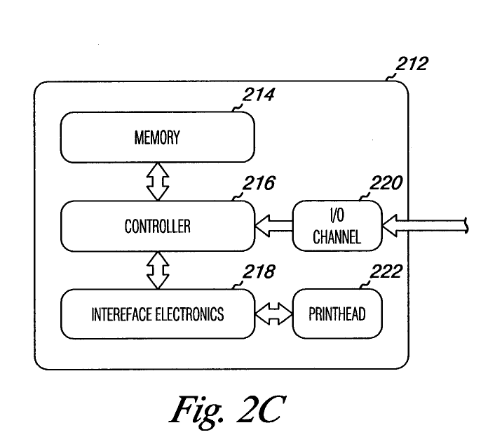

FIG. 2A illustrates a printing device with which embodiments can be implemented. The embodiment of FIG. 2A illustrates a multifunction inkjet printer 201, which can be used in a business environment for reports, correspondence, desktop publishing, pictures and the like. However, the invention is not so limited and can include other printers implementing various embodiments of the present invention.

FIG. 2B illustrates a perspective view for a printer media conveyance mechanism 200 with which embodiments can be implemented. In various embodiments, the printer media conveyance mechanism 200 includes a rotating drum 204 for advancing print media 210 to one or more printheads 202. The rotating drum 204 is adapted with multiple apertures 203. A partial vacuum is created within the drum 204, causing the print media 210 to adhere to the surface of the drum 204. The drum 204 is rotated to convey the print media 210 to the one or more printheads 202. In various embodiments the one or more printheads 202 are operable to move across the print media 210 during the printing process. In other embodiments of the printer media conveyance mechanism 200, the print media 210 can be held against the drum 204 by using an electrostatic charge, or adhesives. The print media 210 can also be held against the drum 204 by using one or more clips, pins, clamps, fasteners, snaps, among others.

FIG. 2C illustrates an embodiment of electronic components 212 associated with a printer, such as printer 102 in FIG. 1 or 201 shown in FIG. 2A. As illustrated in FIG. 2C, the electronic components 212 include a printhead 222. As used herein, “a” printhead is not intended to mean only one. More than one printhead can be included. As one of ordinary skill in the art will appreciate, each printhead has multiple nozzles. Interface electronics 218 are included to interface between the control logic components and the electromechanical components of the printer. Interface electronics 218 include, for example, circuits for moving the printhead and media, as well as circuitry for firing individual nozzles.

As shown in FIG. 2C, the electronic components 212 includes control logic in the form of a processor 216. As used herein, processor 216 can serve as a controller. The control logic can further include memory components 214. Processor 216 is operable to read and execute computer executable instructions received from memory 214 or elsewhere. These instructions carry out various control steps and functions for a printer. Memory 214 can include some combination of ROM, dynamic RAM, and/or some type of nonvolatile and writeable memory such as battery-backed memory or flash memory.

The processor 216 can be interfaced, or connected, to receive instructions and data from a remote device (e.g. host computer), such as 110 shown in FIG. 1, through one or more I/O channels or ports 220. I/O channel 220 can include a parallel or serial communications port, and/or a wireless interface for receiving information, e.g. print job data.

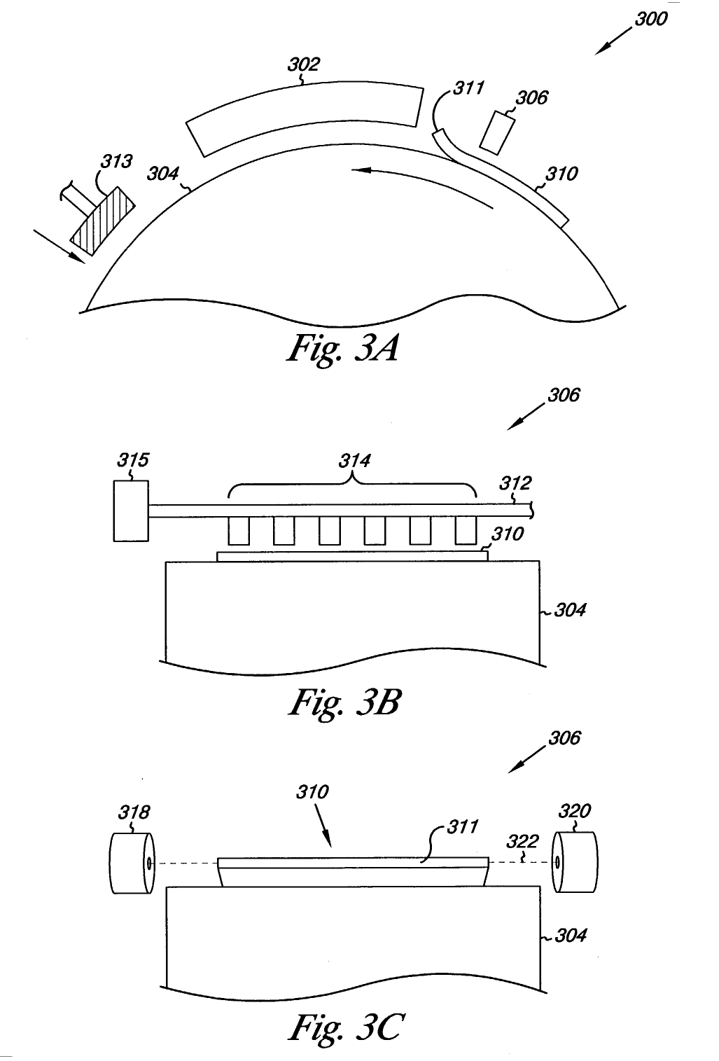

FIG. 3A illustrates an end on view of a printhead protection device 300. In this embodiment, a movable carriage conveyance mechanism 302 which transports printheads over media is positioned in relatively close proximity to a drum 304. In various embodiments the drum 304 serves as part of a print media conveyance mechanism such as the one shown in FIG. 2B. The drum 304 can accommodate more rapid print media delivery to the printheads in the carriage conveyance mechanism 302 than traditional roller and platen media handlers in inkjet printers. A print media detection component 306 is positioned opposing relative to the transport of a print media 310 and in proximity to the printheads in the carriage conveyance mechanism 302. In various embodiments the print media detection component 306 senses a position of print media 310 above the drum 304, and performs a reference comparison with the printheads in the carriage conveyance mechanism 302 above the drum 304. If the print media detection component 306 senses that the print media 310 has a nonconforming position 311, and a collision between the print media 310 and the printheads in the carriage conveyance mechanism 302 can ensue, the print media detection component 306 causes remedial action to be taken. FIG. 3A provides one example of a nonconforming position 311 to the print media 310. In this example a front edge of the print media 310 has separated and is displaced from the drum 304 such that the edge or nonconforming position 311 of the print media 310 will collide with the printheads in the carriage conveyance mechanism 302. In one embodiment, the remedial action can include activating a braking mechanism, or drum brake 313 to stop movement of the drum 304.

FIG. 3B illustrates portions of an embodiment for a media detection device 306. As was shown in FIG. 3A, media on a drum-type conveyance mechanism 304 is transported past a media detection device/component 306 as it is advanced toward printheads in the carriage conveyance mechanism 302. Media detection component 306 includes a rotatable axis member 312 having one or more detect members 314 and a sensor or electronic switch 315 coupled to axis member 312. As one of ordinary skill in the art will appreciate, the axis member 312 can be constructed in many forms, such as one or more levers, pulleys, or rotating shafts. The axis member 312 can also include one or more idler arms, springs, clips, elastic strips, pistons, pushrods, wheels, gears, capstans, among others. Each of the one or more detect members 314 have a first end that is coupled to the axis member 312, and a second end opposing the drum 304. The one or more detect members 314 can be positioned such that the second end of the one or more detect members 314 can detect print media 310 that has a nonconforming position (shown as 311 in the illustrations of FIGS. 3A and 3C). In various embodiments, the one or more detect members 314 can be constructed of relatively rigid material, or can be more flexible. In one embodiment, the one or more detect members 314 can be constructed in the form of planar sheets of material. In various embodiments, the one or more detect members 314 can be constructed in many other forms, such as one or more strips, membranes, or studs. The one or more detect members 314 can also include one or more detents, levers, wires, springs, switches, relays, among others. In a condition where the print media 310 is nonconforming in position, the print media 310 strikes the one or more detect members 314, causing the one or more detect members 314 to respond. Response of the one or more detect members 314 can actuate the axis member 312. The actuation of the axis member 312 can be sensed by sensor 315, triggering remedial action.

FIG. 3C illustrates portions of another embodiment for a media detection device 306. As was shown in FIG. 3A, media on a drum-type conveyance mechanism 304 is transported past a media detection device/component 306 as it is advanced toward a printhead 302. In the embodiment shown in FIG. 3C, media detection device, or component, 306 is constructed as an optical sensor that includes a light emitter 318 and a light receptor 320. As the printer drum 304 advances print media 310, an optical sensor is utilized to detect print media 310 that is nonconforming in position. If print media 310 with nonconforming position interferes with a light beam 322 projected from the light emitter 318, the receptor 320 can trigger remedial action. The remedial actions taken in the various embodiments include such actions as stopping or delaying advancement of the print media 310, applying shielding mechanisms, executing a set of instructions for correcting media feed processes, collecting data on system, component or device conditions, triggering an alert signal to a user, slowing the printing process, among others. The invention is not so limited.

FIG. 3C provides one example of a nonconforming position 311 to the print media 310. In this example an edge 311 of the print media 310 has separated from the drum 304 such that the edge or nonconforming position 311 of the print media 310 interrupts the light beam 322.

The media detection component 306 shown in the embodiments of FIGS. 3A-3C interfaces with a controller, such as controller 216 shown in FIG. 2C to register a nonconforming position 311 of the print media 310. The media detection component 306 also interfaces with the controller to enable the remedial actions described herein.

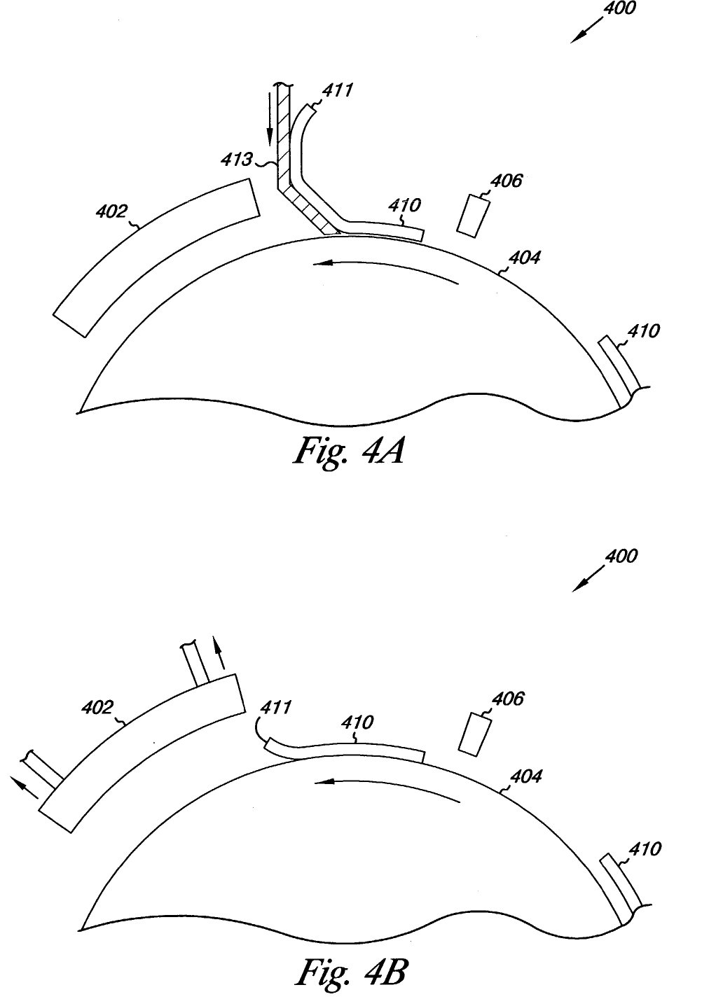

FIG. 4A illustrates a side view of another embodiment of a printhead protection device 400. This embodiment includes printheads 402, a printer drum 404, and media detection component 406, such as the media detection components described in connection with FIGS. 3B and 3C. In the embodiment of FIG. 4A, if the media detection component 406 detects print media 410 that has a nonconforming position 411, the media detection component 406 can trigger remedial action by operating a media diversion mechanism 413. The media diversion mechanism 413, such as a sheet diverter 413, can divert the print media 410 in various ways, such as routing the print media 410 away from the one or more printheads 402, by blocking the further advancement of the print media 410, and/or by containing the print media 410, among others. The invention is not so limited.

FIG. 4B illustrates a side view of another embodiment of a printhead protection device 400. This embodiment includes printheads 402, a printer drum 404, and a print media detection component 406. In the embodiment of FIG. 4B, if print media 410 has a nonconforming position 411, the print media detection component 406 can trigger remedial action by moving the printheads 402 to prevent or minimize the risk of a collision with the print media 410.

As with FIGS. 3A-3C, the media detection component 406 in FIGS. 4A and 4B interfaces with a controller, such as controller 216 shown in FIG. 2C to register a nonconforming position 411 of the print media 410 and to enable the remedial actions described herein.

As one of ordinary skill the art will understand, the remedial actions can be performed by the controller operating on a set of computer executable instructions. Such instructions can be resident in memory such as the memory 214 shown in FIG. 2 or in memory 106 and 114 shown in the system of FIG. 1. The invention, however, is not limited to computer executable instructions written in a particular programming language.

This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. Therefore, the scope of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A device, comprising;
a printhead;
a drum to carry print media along a media path to a printhead;
a detector disposed upstream from the printhead along the media path, the detector configured to detect print media which will collide with the printhead; and
a sheet diverter operatively coupled to the detector, the sheet diverter operative, in response to the detector detecting print media which will collide with the printhead, to divert the print media away from the printhead.

2. The device of claim 1, wherein the device further includes a controller interfaced to the detector and operable to take remedial action to avoid a collision between the print media and the printhead.

3-6. (Canceled)

7. A printing device, comprising:
a printhead positioned on a carriage conveyance mechanism;
a media conveyance mechanism operable to move print media to the printhead; and
a detection mechanism disposed upstream from the carriage conveyance mechanism along a media path having one or more detect members affixed to a rotatable member and operable to detect potential collisions between the print media and the printhead.

8. The printing device of claim 7, wherein the detection mechanism is operable to take remedial action to prevent a collision between the print media and the printhead by altering a path of the print media.

9. The printing device of claim 7, wherein the detection mechanism is operable to prevent a collision between the print media and the printhead by moving the carriage conveyance mechanism.

10. The printing device of claim 7, wherein the detection mechanism is operable to trigger remedial action to prevent a collision between the print media and the printhead by stopping movement of the media conveyance mechanism.

11. The printing device of claim 7, wherein the printing device includes an inkjet printer.

12. The printing device of claim 7, wherein the media conveyance mechanism is a drum.

13. A media detection device, comprising;
an optical sensor disposed upstream from a carriage conveyance mechanism along a media path to detect misaligned print media;
a controller operable, when triggered by the optical sensor, to prevent a collision between misaligned print media and a printhead, and
a sheet diverter operatively coupled to the controller, the sheet diverter operative, in response to the controller detecting print media displaced from the media path, to divert the misaligned print media away from the printhead.

14. The media detection device of claim 13, wherein the optical sensor includes a light emitter and a light receptor.

15. A printhead protection system, comprising:
a printhead positioned on a carriage conveyance mechanism;
a print media conveyance component operable to move print media to the printhead;
a detection mechanism disposed upstream from the carriage conveyance mechanism along a media path and operable to detect potential collisions between the print media and the printhead; and
means for preventing collision between the printhead and print media with a sheet diverter operatively coupled to the detection mechanism when print media is in a nonconforming position on the print media conveyance component.

16. The printhead protection system of claim 15, wherein the means for preventing collision between the printhead and print media includes a media detection device operable to detect the nonconforming position of the print media.

17. The printhead protection system of claim 16, wherein the means for preventing collision between the printhead and print media includes a controller coupled to the media detection device, the controller operable to take remedial action when print media is in a nonconforming position on the print media conveyance component.

18. The printhead protection system of claim 17, wherein controller operable to take remedial action when print media is in a nonconforming position on the print media conveyance component includes a controller operable to stop movement of the print media conveyance component.

19. A printing system, comprising:
a printing device, wherein the printing device includes;
a print media conveyance component operable to advance print media to a printhead positioned on a carriage conveyance mechanism;
a print media detector disposed upstream from the carriage conveyance mechanism along a media path having one or more detect members affixed to a rotatable member and operable to detect a nonconforming position of the print media; and
a controller operable to be triggered by the print media detector to take remedial action to prevent the print media from striking the printhead; and
a host device connected to the printing device and operable to transmit a print job to the printing device over one or more data links.

20. A method of protecting a printhead, comprising:
advancing print media toward a printhead;
detecting a nonconforming position of the print media with one or more detect members affixed to a rotatable member from a position upstream from the carriage conveyance mechanism along a media path; and
in response to detecting a nonconformning position, preventing a collision between the print media and the printhead.

21. The method of claim 20, wherein preventing a collision includes braking a drum carrying the print media.

22. The method of claim 20, wherein preventing a collision includes moving the printhead away from a print media conveyance mechanism.

23. The method of claim 20, wherein preventing a collision includes routing the print media away from the printhead.

24. A computer-readable medium having a set of computer executable instructions thereon for causing a device to perform a method, the method comprising:
advancing print media toward a printhead;
detecting a nonconforming position of the print media from a position upstream from the carriage conveyance mechanism along a media path; and
in response to detecting a nonconforming position, preventing a collision between the print media and the printhead using a sheet diverter.

25. The computer-readable medium of claim 24, wherein advancing print media toward a printhead includes advancing the print media using a rotating drum.

26. The computer-readable medium of claim 24, wherein detecting a nonconforming position of the print media includes utilizing optical sensors.

27. The computer-readable medium of claim 24, wherein detecting a nonconforming position of the print media includes utilizing contact members.

28. A device, comprising:
a printhead positioned on a carriage conveyance mechanism;
a rotatable drum disposed adjacent to the printhead, the drum configured to carry print media along a media path past the printhead;
a detector disposed upstream from the carriage conveyance mechanism along the media path, the detector having one or more detect members affixed to a rotatable member and configured to detect print media displaced from the drum; and
a drum brake operatively coupled to the detector, the brake operative, in response to the detector detecting print media displaced from the drum, to stop the drum from carrying the print media past the printhead.

29. A device, comprising:
a printhead;
a rotatable drum disposed adjacent to the printhead, the drum configured to carry print media along a media path past the printhead;
a detector disposed adjacent to the drum upstream from the printhead along the media path, the detector configured to detect print media displaced from the drum; and
a sheet diverter operatively coupled to the detector, the diverter operative, in response to the detector detecting print media displaced from the drum, to divert the print media away from the printhead.

30. A device, comprising:
a printhead;
a rotatable drum disposed adjacent to the printhead, the drum configured to carry print media along a media path past the printhead;
at least two detectors disposed upstream from the printhead along the media path and arrayed transversely across the media path, the detectors configured to detect print media displaced from the drum, wherein one of the at least two detectors has one or more detect members affixed to a rotatable member; and
a printhead carriage operatively coupled to the detector, the carriage operative, in response to the detector detecting print media displaced from the drum, to move the printhead away from the drum.

31. A device, comprising;
a printhead;
a drum to carry print media along a media path to a printhead;
a detector disposed adjacent to the drum upstream from the printhead along the media path, the detector configured to detect print media which will collide with the printhead; and
a sheet diverter operatively coupled to the detector, the diverter operative, in response to the detector detecting print media displaced from the drum, to divert the print media away from the printhead.

32. A device, comprising;
a printhead;
a drum to carry print media along a media path to a printhead; and
a detector disposed adjacent to the drum upstream from the printhead along the media path, the detector configured to detect print media which will collide with the printhead and having one or more detect members affixed to a rotatable member.

33. The device of claim 32, wherein the rotatable member is coupled to an electrical switch.

34. The device of claim 32, wherein the one or more detect members are pliable.

35. The device of claim 1, wherein the detector includes one or more detect members affixed to a rotatable member.

36. The printing device of claim 7, wherein the detection mechanism is operable to prevent a collision between the print media and the printhead by moving a sheet diverter operatively coupled to the detection mechanism to divert the print media away from the printhead.

37. The printhead protection system of claim 16, wherein the media detection device includes one or more detect members affixed to a rotatable member.

38. The printing system of claim 19, the printing device further including a sheet diverted operatively coupled to the print media detector, the diverter operative, in response to the print media detector detecting print media in the nonconforming position on the carriage conveyance mechanism, to divert the print media away from the printhead.
